(19) United States
(12) Patent Application Publication
(10) Pub. No.: US 2023/0034245 A1
(43) Pub. Date: Feb. 2, 2023

(54) LBM-BASED FLUID ANALYSIS SIMULATION DEVICE, METHOD, AND COMPUTER PROGRAM

(71) Applicant: E8IGHT CO., LTD, Seongnam-si Gyeonggi-do (KR)

(72) Inventor: Ho Jun KIM, Yangju-si Gyeonggi-do (KR)

(73) Assignee: E8IGHT CO., LTD, Seongnam-si Gyeonggi-do (KR)

(21) Appl. No.: 17/784,677

(22) PCT Filed: Dec. 31, 2019
(86) PCT No.: PCT/KR2019/018756

§ 371 Date: Jun. 13, 2022

(30) Foreign Application Priority Data
Dec. 13, 2019 (KR) 10-2019-0166622

(51) Int. Cl. G06F 30/28

(52) U.S. Cl. CPC G06F 30/28; G06F 2111/10

(57) ABSTRACT

A Lattice Boltzmann method (LBM)-based fluid analysis simulation device comprises: an input unit for receiving data on an analysis object in order to perform a fluid analysis simulation; a grid generation unit for generating a calculation grid system and an output grid system on the basis of the received data, wherein the calculation grid system is for calculating flow data, and the output grid system is for outputting an analysis result; a flow data calculation unit for calculating flow data on a plurality of particles on the basis of the calculation grid system; and a simulation execution unit for executing the fluid analysis simulation on the basis of the output grid system.

### BACKGROUND OF THE DISCLOSURE

### Technical Field

The present invention relates to a device, a method, and a computer program for performing a Lattice Boltzmann Method (LBS)-based fluid analysis simulation.

### Background Art

Computational fluid dynamics (CFD) as a field of fluid dynamics calculates a dynamic motion of a fluid using a computer in a numerical analytical method. The CFD calculates the flow of the fluid by discretizing a Naiver-Stokes Equation which is a partial differential equation through methods such as Finite Difference Method (FDM), Finite Element Method (FEM), Finite Volume Method (FVM), and Smoothed Particle Hydrodynamics (SPH).

There are two methods for calculating the Navier-Stokes equation: a grid-based method that discretizes a spatial domain into a small mesh or grid, and a particle-based method that expresses a fluid as a set of multiple particles.

In the particle-based method, a more natural simulation of natural or physical phenomena is possible by expressing an analysis target as particles instead of using a grid. The particle-based method includes Smoothed Particle Hydrodynamics (SPH), Moving Particle Semi-implicit (MPS), Lattice Boltzmann Method (LBM), etc.

One of the particle-based methods, LBM (Lattice Boltzmann Method)-based fluid analysis predicts a motion using probability distribution functions of virtual particles on a grid (lattice). The LBM-based fluid analysis can produce accurate results while reducing a calculation amount even when the scale of the system is increased.

The LBM-based fluid analysis can easily perform the calculation of physical quantities and can relatively easily perform complex boundary or multiphase flow analysis.

Due to the advantages, recently, LBM has been widely used in simulating the flow of the fluid.

However, when the size of the grid is set differently depending on the area, there is a problem regarding how to process the calculated value and the output value at the boundary surface between areas having different sizes of the grid.

Meanwhile, Korean Patent Registration No. 1489708 discloses a configuration for spreading information to neighboring nodes in fluid numerical analysis based on the Lattice Boltzmann technique.

### SUMMARY OF THE DISCLOSURE

An object of the present invention is to provide a device, a method, and a computer program for performing a fluid analysis simulation that can efficiently process a calculation value and an output value at a boundary surface between regions with different grid sizes.

However, a technical object to be achieved by the embodiment of the present invention is not limited to the technical objects and there may be other technical objects.

As a means for achieving the technical object, an embodiment of the present invention may provide a Lattice Boltzmann Method (LBM)-based fluid analysis simulation device which includes: an input unit receiving data regarding an analysis target for a fluid analysis simulation; a grid generation unit generating a calculation grid system for calculating flow data and an output grid system for outputting an analysis result based on the received data; a flow data calculation unit calculating flow data regarding a plurality of particles based on the calculation grid system; and a simulation performing unit performing the fluid analysis simulation based on the output grid system.

In an embodiment, the calculation grid system may include a first calculation grid system and a second calculation grid system which is denser than the first calculation grid system, and the grid generation unit may assign a number to a grid point of each of the first calculation grid system and the second calculation grid system.

In an embodiment, in a region where the first calculation grid system and the second calculation grid system overlap, all grid points of the first calculation grid system may overlap with the grid points of the second calculation grid system.

In an embodiment, the LBM-based fluid analysis simulation device may further include an information exchange unit exchanging information between the plurality of grid systems in the region where the first calculation grid system and the second calculation grid system overlap.

In an embodiment, the information exchange unit may include an exchange information generation unit generating exchange information for transferring information on overlapping grid points where the first calculation grid system and the second calculation grid system overlap in the region where the first calculation grid system and the second calculation grid system overlap, and an information transmission unit transferring information from any one of the first calculation grid system and the second calculation grid system to the other based on the exchange information.

In an embodiment, the exchange information generation unit may generate the exchange information based on whether the grid points of the first calculation grid system and the second calculation grid system overlap and the numbers of the overlapping grid points.

In an embodiment the flow data calculation unit may calculate the flow data regarding the plurality of particles for each of the first calculation grid system and the second calculation grid system.

In an embodiment, the grid points of the output grid system may overlap with both the grid point of the first calculation grid system and the grid point of the second calculation grid system.

In an embodiment, the information transmission unit may transfer the calculated flow data from any one of the first calculation grid system and the second calculation grid system to the grid point of the output grid system, and the simulation performing unit may perform a simulation for the plurality of particles by outputting the calculated flow data to the output grid system.

Another embodiment of the present invention may provide a Lattice Boltzmann Method (LBM)-based fluid analysis simulation method which includes: receiving data regarding an analysis target for a fluid analysis simulation; generating a calculation grid system for calculating flow data based on the received data; generating an output grid system for outputting an analysis result; calculating flow data regarding a plurality of particles based on the calculation grid system; and performing the fluid analysis simulation based on the output grid system.

Yet another embodiment of the present invention may provide a computer program stored in a medium including a sequence of instructions for performing a Lattice Boltzmann Method (LBM)-based fluid analysis simulation, in which when the computer program is executed by a computing device, the computer program includes a sequence of instructions for instructing receiving data regarding an analysis target for a fluid analysis simulation; generating a calculation grid system for calculating flow data and an output grid system for outputting an analysis result based on the received data; calculating flow data regarding a plurality of particles based on the calculation grid system; and performing the fluid analysis simulation based on the output grid system.

The problem-solving means is just exemplary, and should not be interpreted as an intention of limiting the present invention. In addition to the exemplary embodiment, an additional embodiment may exist, which is disclosed in drawings and a detailed description of the present invention.

According to any one of the technical solutions of the present invention, it is possible to provide a device, a method, and a computer program for performing a fluid analysis simulation which are capable of efficiently processing a calculation value and an output value at a boundary surface between areas with different grid sizes.

Further, a calculation grid system and an output grid system are separated to reduce costs and a time required for calculation for a fluid analysis simulation.

In addition, by effectively predicting the movement of a fluid, the present invention can be applied to various technical fields.

### BRIEF DESCRIPTION OF THE DRAWINGS

FIG. 1 is a configuration diagram of a fluid analysis simulation device according to an embodiment of the present invention.

FIG. 2 exemplarily illustrates a calculation grid system and an output grid system according to an embodiment of the present invention.

FIG. 3 is a diagram for describing a method for transferring, by a calculation grid system, information according to an embodiment of the present invention.

FIG. 4 is a diagram for describing a method for transferring, by a calculation grid system, information according to an embodiment of the present invention.

FIG. 5 is a flowchart of a fluid analysis simulation method according to an embodiment of the present invention.

### DETAILED DESCRIPTION OF THE DISCLOSURE

Hereinafter, embodiments of the present invention will be described in detail so as to be easily implemented by those skilled in the art, with reference to the accompanying drawings. However, the present invention may be implemented in various different forms, and is not limited to the embodiments described herein. In addition, in the drawings, in order to clearly describe the present invention, a part not related to the description is omitted and like reference numerals designate like elements throughout the specification.

Throughout the specification, when it is described that a part is “connected” with another part, it means that the part may be “directly connected” with another part and the parts may be “electrically or mechanically connected” to each other with still another element interposed therebetween. Further, when a part “includes” a component, it means that other components may be further included, rather than excluding other components, unless otherwise stated, and it is to be understood that the existence or addition of one or more other features or numbers, steps, operations, components, parts, or combinations thereof is not precluded in advance.

In this specification, a ‘unit’ includes a unit realized by hardware, a unit realized by software, and a unit realized using both. In addition, one unit may be implemented using two or more hardware, and two or more units may be implemented by one hardware. Meanwhile, ‘unit’ is not a meaning limited to the software or hardware and ‘unit’ may be configured to be positioned in a storage medium which is addressable or configured to reproduce one or more processors. Accordingly, as one example, the “unit” includes components such as software components, object-oriented software components, class components, and task components, processes, functions, attributes, procedures, subroutines, segments of a program code, drivers, firmware, microcode, circuitry, data, databases, data structures, tables, arrays, and variables. Functions provided in the components and the “units” may be combined into a smaller number of components and “units” or further separated into additional components and “units”. Moreover, the components and the ‘units’ may be implemented to reproduce one or more CPUs in a device or a secure multimedia card.

Some of the operations or functions described as being performed by a terminal or device in this specification may be instead performed by a server connected to the terminal or device. Similarly, some of the operations or functions described as being performed by the server may also be performed in a terminal or device connected to the server.

Hereinafter, an embodiment of the present invention will be described in detail with reference to the accompanying drawings.

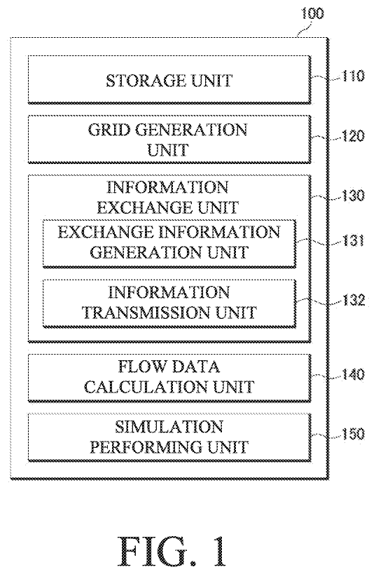

FIG. 1 is a configuration diagram of a fluid analysis simulation device according to an embodiment of the present invention. Referring to FIG. 1, the fluid analysis simulation device 100 may include an input unit 110, a grid generation unit 120, an information exchange unit 130, a flow data calculation unit 140, and a simulation performing unit 150.

The fluid analysis simulation device 100 may include a server, a desktop, a notebook computer, a KIOSK and a smartphone, and a tablet PC. However, the fluid analysis simulation device 100 is not limited to the exemplified devices above. That is, the fluid analysis simulation device 100 may include all devices equipped with a processor for performing an LBM-based fluid analysis simulation method to be described later.

The fluid analysis simulation device 100 performs a three-dimensional flow analysis of the fluid. That is, the fluid analysis simulation device 100 models a three-dimensional simulation region and a plurality of particles positioned in the three-dimensional simulation region, and analyzes the flow of the plurality of particles in the three-dimensional simulation region. However, in the present specification, for convenience of description, the simulation region and particles are expressed and described in two dimensions.

The fluid analysis simulation device 100 may perform a simulation for analyzing a fluid based on Lattice Boltzmann Method (LBM). The Lattice Boltzmann Method (LBM) is one of the particle-type fluid analysis techniques which may be used in Computational Fluid Dynamics (CFD). In order to simulate the motion of the fluid, the LBM may express a fluid to be analyzed as particles on the grid. The fluid analysis simulation device 100 may calculate a physical quantity of each particle while tracking each particle through the LBM, and perform the fluid analysis simulation based on the calculation result.

The input unit 110 may receive data regarding the analysis target for the fluid analysis simulation. For example, the input unit 110 may receive the data regarding the analysis target from an external device such as a user terminal.

The input unit 110 may also receive the data regarding an analysis target through communication with an external server. The data regarding the plurality of particles may include information regarding the analysis target required for performing the fluid analysis simulation. The data on the analysis target may include information on flow information and analysis conditions of the fluid which is the analysis target, and may include, for example, at least one of an initial density, viscosity, and initial velocity of the fluid which is the analysis target.

The grid generation unit 120 may generate one or more grid systems based on the received data. The grid generation unit 120 may generate a calculation grid system or an output grid system. The grid generation unit 120 may generate a grid system for the entirety or a part of the space. The grid generation unit 120 may generate the grid system such that a region where a plurality of grid systems overlap with each other exists.

The grid generation unit 120 may determine a grid spacing of the grid system based on data such as positions and velocities of a plurality of particles. The grid generation unit 120 may generate a grid system in which the spacing of grids varies according to the region.

The grid generation unit 120 may generate a calculation grid system for calculating the flow data. The grid generation unit 120 may generate a first calculation grid system based on the data regarding the analysis target. The grid generation unit 120 may generate a second calculation grid system which is denser than the first calculation grid system based on the data regarding the analysis target. This is because, when a coarse grid system is used in the entire region, the accuracy of analysis is lowered, and on the contrary, when a dense grid system is used in the entire region, an excessive amount of computation is required. Therefore, in the present invention, a multi-block method is used in which a grid of a relatively small size is used only for a region of interest, and a grid of a relatively large size is used for other regions.

In a region where the first calculation grid system and the second calculation grid system overlap, all grid points of the first calculation grid system may overlap with the grid points of the second calculation grid system. That is, the spacing of the grids of the first calculation grid system may be an integer multiple of the spacing of the grids of the second calculation grid system.

The grid generation unit 120 may assign a number to each grid point of the first calculation grid system and the second calculation grid system. For example, the grid generation unit 120 may sequentially assign a number to each grid point of the first calculation grid system from number 1, and sequentially assign, to each grid point of the second calculation grid system, numbers by starting at a next number of a last number assigned to the grid point of the first calculation grid system.

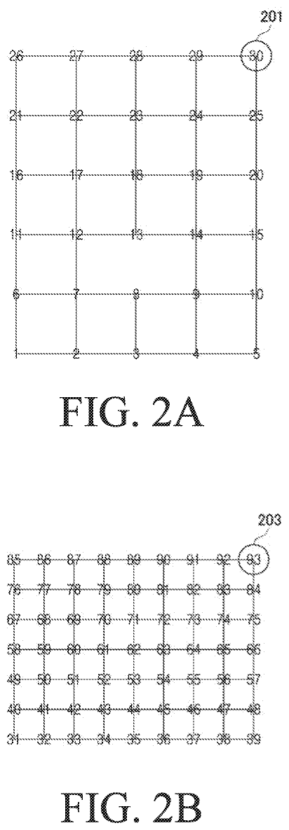

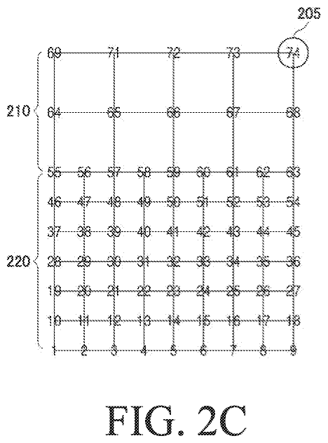

FIGS. 2A and 2B exemplarily illustrate the first calculation grid system and the second calculation grid system generated based on the received data. FIG. 2A illustrates the first calculation grid system and FIG. 2B illustrates the second calculation grid system.

The second calculation grid system is formed more densely than the first calculation grid system. The second calculation grid system is formed so as to overlap with the region where the grid points 1 to 20 of the first calculation grid system exist. Therefore, in the region where the first calculation grid system and the second calculation grid system overlap, all grid points of the first calculation grid system may overlap with the grid points of the second calculation grid system.

Referring to FIG. 2A, it can be seen that numbers 1 to 30 are sequentially assigned to each grid point 201 of the first calculation grid system. Referring to FIG. 2B, it can be seen that numbers 31 to 93 are sequentially assigned to each grid point 203 of the second calculation grid system.

The grid generation unit 120 may generate an output grid system for outputting an analysis result. The grid points of the output grid system may overlap with both the grid point of the first calculation grid system and the grid point of the second calculation grid system.

FIG. 2C exemplarily illustrates the output grid system generated based on received data. Referring to FIG. 2C, the output grid system may be generated so that the spacing of the grid varies according to regions based on the data regarding the analysis target. For example, it can be seen that the grid spacing is relatively wide in a first region 210 of the output grid system, and the grid spacing is relatively narrow in a second region 220.

Referring to FIG. 2C, it can be seen that numbers 1 to 74 are sequentially assigned to each grid point 205 of the output grid system. That is, the number of the grid point of the output grid system may be independently assigned regardless of the number of the grid point of the calculation grid system.

Referring back to FIG. 1, the information exchange unit 130 may exchange information between a plurality of grid systems in the region where the first calculation grid system and the second calculation grid system overlap. The information exchange unit 130 may include an exchange information generation unit 131 and an information transmission unit 132.

The exchange information generation unit 131 may generate exchange information for transferring information on overlapping grid points where the first calculation grid system and the second calculation grid system overlap in the region where the first calculation grid system and the second calculation grid system overlap.

The exchange information generation unit 131 may generate exchange information based on whether the grid points of the first calculation grid system and the second calculation grid system overlap and the number of the overlapping grid points. The exchange information generation unit 131 may generate the exchange information in order to exchange information with the first calculation grid system at the boundary surface of the second calculation grid system or in order to exchange information with the second calculation grid system at the boundary surface of the first calculation grid system, for example.

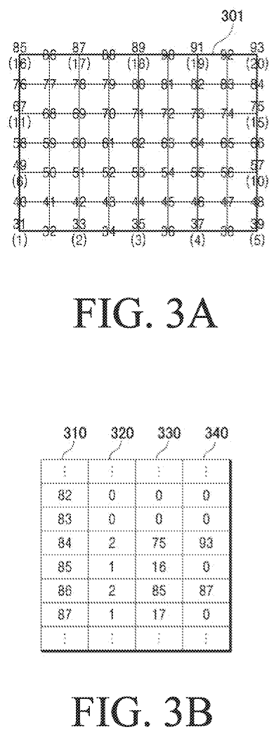

FIGS. 3A and 3B are diagrams for describing a method for generating exchange information in order to exchange information with the first calculation grid system at the boundary surface of the second calculation grid system illustrated in FIG. 2B. As illustrated in FIG. 3A, a boundary surface 301 of the second calculation grid system is a region for exchanging information with the first calculation grid system, and the boundary surface 301 of the second calculation grid system may be formed along an outline of the second calculation grid system. On the boundary surface 301 of the second calculation grid system, information which the second calculation grid system does not have may be transferred from the first calculation grid system. FIG. 3A exemplarily illustrates the number of each grid point of the second calculation grid system, and the number of the grid point of the first calculation grid system which overlaps with the grid point of the second calculation grid system on the boundary surface 301 of the second calculation grid system.

Referring to FIG. 3B, the exchange information generation unit 131 may generate first exchange information including grid point information 310, overlapping information 320, first exchange target grid point information 330, and second exchange target grid point information 340. The grid point information 310 may include the number of each grid point of the second calculation grid system.

The exchange information generation unit 131 may generate the overlapping information 320 based on whether the grid point of the boundary surface 301 of the second calculation grid system overlaps with the grid point of the first calculation grid system in response to the number of each grid point of the second calculation grid system. For example, the exchange information generation unit 131 may generate the overlapping information 320 in which when the grid point of the boundary surface 301 of the second calculation grid system overlaps with the grid point of the first calculation grid system, 1 is recorded and when the grid point of the boundary surface 301 of the second calculation grid system does not overlap with the grid point of the first calculation grid system, 2 is recorded, and when the corresponding grid point is not the grid point of the boundary surface 301 of the second calculation grid system, 0 is recorded.

The exchange information generation unit 131 may record, as 0, the first exchange target grid point information 330 and the second exchange target grid point information 340 corresponding to the grid point of the second calculation grid system in which the overlapping information 320 is 0.

The exchange information generation unit 131 may record the first exchange target grid point information 330 corresponding to the grid point of the second calculation grid system in which the overlapping information 320 is 1 as the number of the grid point of the first calculation grid system which overlaps with the grid point of the second calculation grid system, and record the second exchange target grid point information 340 as 0.

The exchange information generation unit 131 may record the first exchange target grid point information 330 and the second exchange target information 340 corresponding to the grid point of the second calculation grid system in which the overlapping information 320 is 2 as one of numbers of grid points adjacent to the grid point of the second calculation grid system among the grid points of the second calculation grid system which overlaps with the grid point of the first calculation grid system.

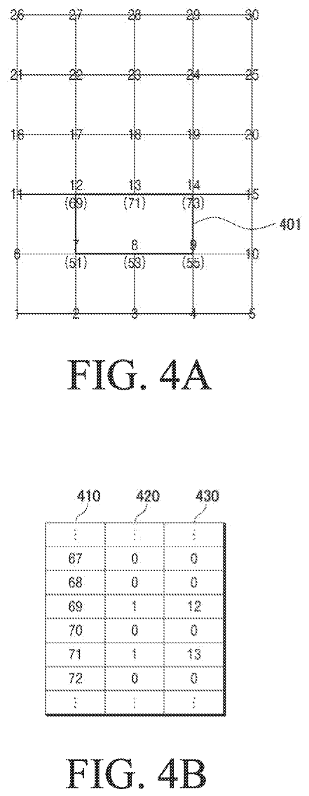

FIGS. 4A and 4B are diagrams for describing a method for generating exchange information in order to exchange information with the second calculation grid system at the boundary surface of the first calculation grid system illustrated in FIG. 2A. As illustrated in FIG. 4A, a boundary surface 401 of the first calculation grid system is a region for exchanging information with the second calculation grid system, and the boundary surface 401 of the first calculation grid system may be formed along grid points which move as large as a size of one grid of the first calculation grid system toward the interior from the boundary surface of the second calculation grid system. On the boundary surface 401 of the first calculation grid system, information which the first calculation grid system does not have may be transferred from the second calculation grid system. FIG. 4A exemplarily illustrates the number of each grid point of the first calculation grid system, and the number of the grid point of the second calculation grid system which overlaps with the grid point of the first calculation grid system on the boundary surface 401 of the first calculation grid system.

Referring to FIG. 4B, the exchange information generation unit 131 may generate second exchange information including grid point information 410, overlapping information 420, and exchange target grid point information 430. The grid point information 410 may include the number of each grid point of the second calculation grid system.

The exchange information generation unit 131 may generate the overlapping information 420 based on whether the grid point of the boundary surface 401 of the first calculation grid system overlaps with the grid point of the second calculation grid system in response to the number of each grid point of the second calculation grid system. For example, the exchange information generation unit 131 may generate the overlapping information 420 in which when the grid point of the boundary surface 401 of the first calculation grid system overlaps with the grid point of the second calculation grid system, 1 is recorded and when the grid point of the boundary surface 401 of the first calculation grid system does not overlap with the grid point of the second calculation grid system, 0 is recorded.

The exchange information generation unit 131 may record, as 0, the exchange target grid point information 430 corresponding to the grid point of the second calculation grid system in which the overlapping information 420 is 0.

The exchange information generation unit 131 may record the exchange target grid point information 430 corresponding to the grid point of the second calculation grid system in which the overlapping information 420 is 1 as the number of the grid point of the first calculation grid system which overlaps with the grid point of the second calculation grid system.

Even when the second exchange information for exchanging information is generated on the boundary surface of the first calculation grid system, the reason for using the number of the grid point of the second calculation grid system as a reference is that the second calculation grid system is more densely generated. In other words, the reason is that in the region where the first calculation grid system and the second calculation grid system overlap, all grid points of the first calculation grid system are generated to overlap with the grid points of the second calculation grid system.

The information transmission unit 132 may transfer information from one of the first and second calculation grid systems to the other based on the first exchange information and the second exchange information.

Referring back to FIGS. 3A and 3B, for example, the information transmission unit 132 may transmit information from the first calculation grid system to the second calculation grid system when the grid point of the boundary surface 301 of the second calculation grid system overlaps with the grid point of the first calculation grid system, i.e., when the exchange information 320 is 1. Here, the information may be transferred by using Equation 1 below by referring to the number of the overlapped grid point of the first calculation grid system stored in the first exchange target grid point information 330.

$${\tilde{f}}_{α}^{( f )} = {f}_{α}^{( eq , c )} + \frac{{τ}_{f} - 1}{m ( {τ}_{c} - 1 )} [ {\tilde{f}}_{α}^{( c )} - {f}_{α}^{( eq , c )} ] \qquad [ Equation 1 ]$$

In Equation 1, \tilde{ƒ}_{α}^{(ƒ)} may represent a post collision term in the second calculation grid system, \tilde{ƒ}_{α}^{(ƒ)} may represent the post collision term in the first calculation grid system, τ_{ƒ} may represent a relaxation time in the second calculation grid system, τ_{c} may represent the relaxation time in the first calculation grid system, m may represent a value acquired by dividing the grid size of the first calculation grid system by the grid size of the second calculation grid system, and ƒ_{α}^{(eq,c)} may represent an equilibrium distribution function in the first calculation grid system.

Since information on the outside of the boundary surface is insufficient at the boundary surface of the second calculation grid system, when only information on the second calculation grid system is used, \tilde{ƒ}_{α}^{(ƒ)} the post collision term in the second calculation grid system) may not be accurately derived. Accordingly, the information is transferred from the first calculation grid system to derive \tilde{ƒ}_{α}^{(ƒ)} by using Equation 1 described above. According to Equation 1, values of each flow data such as the density, the velocity, the shear stress, etc., of the fluid may have a consecutive distribution.

As another example, the information transmission unit 132 may interpolate information when the grid point of the boundary surface 301 of the second calculation grid system does not overlap with the grid point of the first calculation grid system, i.e., when the exchange information 320 is 2. Here, the information transmission unit 132 may receive information from an adjacent grid point by referring to the numbers of the grid points of the second calculation grid system stored in the first exchange target grid point information 330 and the second exchange target grid point information 340.

The information transmission unit 132 may interpolate information by using inverse distance weighting. For example, interpolation may be performed by receiving information from an adjacent grid point using Equation 2 below with respect to a grid point 86 illustrated in FIG. 3A.

$${{\tilde{f}}_{α}^{( f )} )}_{86} = \frac{{{\frac{1}{{d}_{85 - 86}} {\tilde{f}}_{α}^{( f )} )}_{86} + \frac{1}{{d}_{87 - 86}} {\tilde{f}}_{α}^{( f )} )}_{87}}{\frac{1}{{d}_{85 - 86}} + \frac{1}{{d}_{87 - 86}}} \qquad [ Equation 2 ]$$

In Equation 2, \tilde{ƒ}_{α}^{(ƒ)})ᵢ represents the post collision term in an i-th grid point and dᵢ₋ⱼ represents a distance between the i-th grid point and a j-th grid point.

Referring back to FIGS. 4A and 4B, for example, the information transmission unit 132 may transmit information from the second calculation grid system to the first calculation grid system when the grid point of the boundary surface 401 of the first calculation grid system overlaps with the grid point of the second calculation grid system, i.e., when the exchange information 420 is 1. Here, the information transmission unit 132 may receive information by using Equation 3 below by referring to the number of the grid point of the first calculation grid system stored in the grid point information 430.

$${\tilde{f}}_{α}^{( c )} = {f}_{α}^{( eq , f )} + m \frac{{τ}_{c} - 1}{{τ}_{f} - 1} [ {\tilde{f}}_{α}^{( f )} - {f}_{α}^{( eq , f )} ] \qquad [ Equation 3 ]$$

In Equation 3, \tilde{ƒ}_{α}^{(c)} may represent the post collision term in the first calculation grid system, \tilde{ƒ}_{α}^{(ƒ)} may represent the post collision term in the second calculation grid system, τ_{c} may represent the relaxation time in the first calculation grid system, τ_{ƒ} may represent the relaxation time in the second calculation grid system, m may represent a value acquired by dividing the grid size of the first calculation grid system by the grid size of the second calculation grid system, and ƒ_{α}^{(eq,ƒ)} may represent the equilibrium distribution function in the second calculation grid system.

Since the information on the outside of the boundary surface is insufficient at the boundary surface of the first calculation grid system, when only the information on the first calculation grid system is used, \tilde{ƒ}_{α}^{(c)} the post collision term in the first calculation grid system) may not be accurately derived. Accordingly, the information is transferred from the second calculation grid system to derive \tilde{ƒ}_{α}^{(c)} by using Equation 3 described above. According to Equation 3, values of each flow data such as the density, the velocity, the shear stress, etc., of the fluid may have the consecutive distribution.

The flow data calculation unit 140 may calculate flow data regarding the plurality of particles based on the calculation grid system. The flow data calculation unit 140 may calculate the flow data regarding the plurality of particles for each of the first calculation grid system and the second calculation grid system.

The flow data calculation unit 140 may calculate flow data generated due to a movement of each particle or a collision between each particle and a neighboring particle on the grid system by using an LBM algorithm.

The flow data calculation unit 140 calculates a value of a distribution function of particles at each grid point using the LBM algorithm, thereby obtaining physical property information at each grid point. The physical property information at each grid point may include, for example, at least one of mass, velocity, viscosity, and acceleration of the particle.

For example, the Boltzmann equation models the fluid as follows.

$$\frac{\partial {f}_{α}}{\partial t} + \overline{{e}_{α}} \cdot ▽ {f}_{α} = {Ω}_{α} \qquad [ Equation 4 ]$$

In Equation 4, “ƒ_{α}” represents a distribution function, “ē_{α}” represents a discrete velocity, “Ω_{α}” represents a collision operator, and “α” represents each direction in the grid system.

Meanwhile, the LBM solves Equation 4 using the method of characteristics, and this process is divided into a collision step and a streaming step.

The analysis of the collision step may be expressed as in Equation 5. In this process, a collision between virtual particles can be simulated using Ωₐ, a collision operator.

\tilde{ƒ}_{α}(\vec{xᵢ},t+δₜ)=ƒ_{α}(\vec{xᵢ},t)+Ω_{α}(\vec{xᵢ},t) [Equation 5]

In Equation 5, \tilde{ƒ}_{α} may represent the post collision term, ƒ_{α} may represent the distribution function, Ω_{α} may represent the collision operator, \vec{xᵢ} may represent the location of the particle, t represents a current time, and δₜ may represent a time variation amount.

The streaming step after the collision step is analyzed by using Equation 6, and a new distribution function is derived through the analyzed streaming step.

ƒ_{α}(\vec{xᵢ}+\vec{e_{α}}δₜ,t+δₜ)=\tilde{ƒ}_{α}(\vec{xᵢ},t+δₜ) [Equation 6]

In Equation 6, \tilde{ƒ}_{α} may represent the post collision term, ƒ_{α} may represent the distribution function, \vec{xᵢ} may represent the location of the particle, \vec{e_{α}} may represent the discrete velocity, t represents the current time, and may represent the time variation amount.

A density of the fluid at each grid point is derived by Equation 7 by using a newly derived distribution function.

$$ρ = {\sum }_{α} {f}_{α} \qquad [ Equation 7 ]$$

In Equation 7, ρ represents the density of the fluid and ƒ_{α} represents the distribution function.

A density of the fluid at each grid point is derived by Equation 8 by using a newly derived distribution function.

$$\overline{V} = \frac{1}{ρ} {\sum }_{α} {f}_{α} \overline{{e}_{α}} \qquad [ Equation 8 ]$$

In Equation 8, ρ represents the density of the fluid, ƒ_{α} represents the distribution function, \vec{e_{α}} represents the discrete velocity, and \vec{V} represents the velocity of the fluid.

The flow data calculation unit 140 calculates flow data such as the density, the pressure, the viscosity, etc., of each particle by using the LBM algorithm. For example, the flow data calculation unit calculates the flow data of each particle in a next time step (a first time step) based on an initial distribution function value of each particle, and calculates the flow data of each particle based thereon.

The flow data calculation unit 140 may perform the fluid analysis simulation by calculating the flow of each particle by calculating the flow data of each particle in each time step.

The information transmission unit 132 may transmit the calculated flow data calculated by the grid point of the output grid system from either one of the first calculation grid system and the second calculation grid system.

The simulation performing unit 150 may perform the fluid analysis simulation based on the output grid system. The simulation performing unit 150 may perform a simulation for the plurality of particles by outputting the calculated flow data to the output grid system.

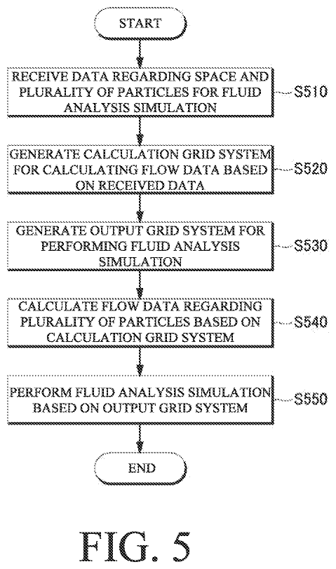

FIG. 5 is a flowchart of a fluid analysis simulation method according to an embodiment of the present invention. A fluid analysis simulation method 500 performed by the device 100 illustrated in FIG. 5 includes steps processed in time series by the device 100 according to the embodiment illustrated in FIG. 1. Accordingly, even contents omitted below are applied to the fluid analysis simulation method performed by the device 100 according to the embodiment illustrated in FIG. 1.

In step S510, the device 100 may receive data regarding the analysis target for the fluid analysis simulation.

In step S520, the device 100 may generate a calculation grid system for calculating the flow data based on the received data.

In step S530, the device 100 may generate an output grid system for outputting an analysis result.

In step S540, the device 100 may calculate flow data regarding a plurality of particles based on a calculation grid system.

In step S550, the device 100 may perform the fluid analysis simulation based on the output grid system.

In the above description, steps S510 to S550 may be further divided into additional steps or combined into fewer steps, according to an embodiment of the present invention. In addition, some steps may be omitted as necessary, and the order between the steps may be switched.

The method of performing fluid analysis simulation in the fluid analysis simulation device described through FIGS. 1 to 5 may be implemented in the form of a computer program stored in a medium executed by a computer or a recording medium including instructions executable by the computer. Further, the method of performing fluid analysis simulation in the fluid analysis simulation device described through FIGS. 1 to 5 may also be implemented in the form of the computer program stored in the medium executed by the computer.

A computer readable medium may be a predetermined available medium accessible by the computer or includes all of volatile and non-volatile media and removable and irremovable media. Further, the computer readable medium may include a computer storage medium. The computer storage medium includes all of the volatile and non-volatile and removable and irremovable media implemented by a predetermined method or technology for storing information such as a computer readable command, a data structure, a program module, or other data.

The aforementioned description of the present invention is used for exemplification, and it can be understood by those skilled in the art that the present invention can be easily modified in other detailed forms without changing the technical spirit or requisite features of the present invention. Therefore, it should be appreciated that the aforementioned embodiments are illustrative in all aspects and are not restricted. For example, respective constituent elements described as single types can be distributed and implemented, and similarly, constituent elements described to be distributed can also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

What is claimed is:

1. A Lattice Boltzmann Method (LBM)-based fluid analysis simulation device comprising:
an input unit receiving data regarding an analysis target for a fluid analysis simulation;
a grid generation unit generating a calculation grid system for calculating flow data and an output grid system for outputting an analysis result based on the received data;
a flow data calculation unit calculating flow data regarding a plurality of particles based on the calculation grid system; and
a simulation performing unit performing the fluid analysis simulation based on the output grid system.

2. The LBM-based fluid analysis simulation device of claim 1, wherein the calculation grid system includes a first calculation grid system and a second calculation grid system which is denser than the first calculation grid system, and
the grid generation unit assigns a number to a grid point of each of the first calculation grid system and the second calculation grid system.

3. The LBM-based fluid analysis simulation device of claim 2, wherein in a region where the first calculation grid system and the second calculation grid system overlap, all grid points of the first calculation grid system overlap with the grid points of the second calculation grid system.

4. The LBM-based fluid analysis simulation device of claim 2, further comprising:
an information exchange unit exchanging information between the plurality of grid systems in a region where the first calculation grid system and the second calculation grid system overlap.

5. The LBM-based fluid analysis simulation device of claim 4, wherein the information exchange unit includes
an exchange information generation unit generating exchange information for transferring information on overlapping grid points where the first calculation grid system and the second calculation grid system overlap in the region where the first calculation grid system and the second calculation grid system overlap, and
an information transmission unit transferring information from any one of the first calculation grid system and the second calculation grid system to the other based on the exchange information.

6. The LBM-based fluid analysis simulation device of claim 5, wherein the exchange information generation unit generates the exchange information based on whether the grid points of the first calculation grid system and the second calculation grid system overlap and the numbers of the overlapping grid points.

7. The LBM-based fluid analysis simulation device of claim 2, wherein the flow data calculation unit calculates the flow data regarding the plurality of particles for each of the first calculation grid system and the second calculation grid system.

8. The LBM-based fluid analysis simulation device of claim 7, wherein grid points of the output grid system overlap with both the grid point of the first calculation grid system and the grid point of the second calculation grid system.

9. The LBM-based fluid analysis simulation device of claim 5, wherein the information transmission unit transfers the calculated flow data from any one of the first calculation grid system and the second calculation grid system to a grid point of the output grid system, and
the simulation performing unit performs a simulation for the plurality of particles by outputting the calculated flow data to the output grid system.

10. A Lattice Boltzmann Method (LBM)-based fluid analysis simulation method comprising:
receiving data regarding an analysis target for a fluid analysis simulation;
generating a calculation grid system for calculating flow data based on the received data;
generating an output grid system for outputting an analysis result;
calculating flow data regarding a plurality of particles based on the calculation grid system; and
performing the fluid analysis simulation based on the output grid system.

11. The LBM-based fluid analysis simulation method of claim 10, wherein the calculation grid system includes a first calculation grid system and a second calculation grid system which is denser than the first calculation grid system, and
the generating of the calculation grid system includes
assigning a number to a grid point of each of the first calculation grid system and the second calculation grid system.

12. The LBM-based fluid analysis simulation method of claim 11, wherein in a region where the first calculation grid system and the second calculation grid system overlap, all grid points of the first calculation grid system overlap with the grid points of the second calculation grid system.

13. The LBM-based fluid analysis simulation method of claim 11, wherein the calculating of the flow data further includes exchanging information between the plurality of grid systems in a region where the first calculation grid system and the second calculation grid system overlap.

14. The LBM-based fluid analysis simulation method of claim 13, wherein the exchanging of the information includes
generating exchange information for transferring information on overlapping grid points where the first calculation grid system and the second calculation grid system overlap in the region where the first calculation grid system and the second calculation grid system overlap, and
transferring information from any one of the first calculation grid system and the second calculation grid system to the other based on the exchange information.

15. The LBM-based fluid analysis simulation method of claim 14, wherein in the generating of the exchange information, the exchange information is generated based on whether the grid points of the first calculation grid system and the second calculation grid system overlap and the numbers of the overlapping grid points.

16. The LBM-based fluid analysis simulation method of claim 11, wherein in the calculating of the flow data, the flow data regarding the plurality of particles is calculated for each of the first calculation grid system and the second calculation grid system.

17. The LBM-based fluid analysis simulation method of claim 16, wherein grid points of the output grid system overlap with both the grid point of the first calculation grid system and the grid point of the second calculation grid system.

18. The LBM-based fluid analysis simulation method of claim 14, wherein the transferring of the information further includes transferring the calculated flow data from any one of the first calculation grid system and the second calculation grid system to a grid point of the output grid system, and
in the performing of the simulation, a simulation for the plurality of particles is performed by outputting the calculated flow data to the output grid system.

19. A computer program stored in a medium including a sequence of instructions for performing a Lattice Boltzmann Method (LBM)-based fluid analysis simulation, wherein when the computer program is executed by a computing device, the computer program includes a sequence of instructions for instructing
receiving data regarding an analysis target for a fluid analysis simulation;
generating a calculation grid system for calculating flow data and an output grid system for outputting an analysis result based on the received data;
calculating flow data regarding a plurality of particles based on the calculation grid system; and
performing the fluid analysis simulation based on the output grid system.
